(19) United States
(12) Patent Application Publication
(10) Pub. No.: US 2009/0288269 A1
(43) Pub. Date: Nov. 26, 2009

(54) SAFETY APPARATUS

(76) Inventor: Philip Ross, Hamilton (GB)

Correspondence Address: DYKAS, SHAVER & NIPPER, LLP, P.O. BOX 877, BOISE, ID, 83701-0877, US

(21) Appl. No.: 11/917,594

(22) PCT Filed: Jun. 15, 2006
(86) PCT No.: PCT/GB06/02200

§ 371 Date: Mar. 31, 2008

(30) Foreign Application Priority Data
Jun. 16, 2005 (GB) 0512275.9

(51) Int. Cl. E05F 5/02

(52) U.S. Cl. 16/82

(57) ABSTRACT

A safety apparatus includes a first member (28) defining a profiled channel (30) and adapted to be coupled to a frame (10) of a closure assembly, and a second member (38) defining a profiled portion (44) and adapted to be coupled to a closure device (12), wherein said profiled portion (44) is adapted to be received within the profiled channel (30) and to rotate therein when the closure device (12) is pivoted relative to the frame (10) to open and close an aperture. In one disclosed embodiment the second member (38) is a pivoting member adapted to be pivotally mounted on the frame (10) of the closure assembly via a pivot assembly (82), wherein said pivoting member is coupled to the closure device (12), such that said closure device (12) is pivotally mounted on the frame (10) via said pivoting member, said pivoting assembly (82) comprising a pivot shaft (40) adapted to extend between the pivoting member and frame (10) and adapted to be retracted into at least one of the pivoting member and frame (10).

### FIELD OF THE INVENTION

The present invention relates to a safety apparatus for use in preventing crushing injuries to portions of the body, and in particular, but not exclusively, to a safety apparatus for use with doors and windows and the like.

The present invention also relates to a closure assembly, and in particular, but not exclusively, to a safety door system.

### BACKGROUND TO THE INVENTION

Crushing injuries to the digits of the hand and foot are commonly caused by becoming trapped between conventional doors and windows and their associated frames. For example, an open door or window permits access of parts of the body, such as fingers or the like, to portions of the frame against which the door or window is intended to engage or move in close proximity to; such regions are commonly referred to as pinch points. A large proportion of crushing injuries caused by doors and windows occur where the fingers or the like become trapped in the pinch points defined along the hinge side and lock side of the doors and Windows. However, perhaps the most severe injuries are caused where fingers or the like become trapped in pinch points created at the hinge side of doors and windows, due to the very large mechanical forces involved.

A number of devices have been proposed to prevent such crushing injuries from occurring. For example, doors which are hung by conventional hinge mechanisms may be fitted with a flexible strip which extends between the door and the door frame to cover the gap created at the hinge side of the door. However, such strips may become worn through prolonged use and must be removed from either the door or its frame when said door is to be removed. Additionally, devices may be fitted to a door or its frame to prevent complete closure of the door, thus eliminating or at least partially reducing the extent of the pinch point created therebetween. Such devices are commonly utilised at the lock side of doors. In many instances, however, such a solution may be impractical where complete closure of the door is consistently required. In such circumstances, any device must be capable of being releasable to permit complete closure of the door when required. However, having to release the device may be considered by users to be an inconvenience, who may permanently release the device and thus eliminate the protection offered.

It is an object of the present invention to obviate or at least mitigate these and other problems with the prior art.

### SUMMARY OF THE INVENTION

According to a first aspect of the present invention, there is provided a safety apparatus comprising:

a first member adapted to be coupled to one of a closure device and frame of a closure assembly, said first member defining a profiled channel; and

a second member adapted to be coupled to the other of the closure device and frame and defining a profiled portion, wherein said profiled portion is adapted to be received within the profiled channel and to rotate therein when the closure device is pivoted relative to the frame to open and close an aperture at least partially defined by said frame,

wherein one of the first and second members is a pivoting member adapted to be pivotally mounted on the frame of the closure assembly via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

Advantageously, in use, the first and second members may prevent a body part from being located between the frame and the closure device in the region of the safety apparatus, thus preventing a body part from being trapped and possibly crushed between the frame and closure device, for example when said closure device is pivoted relative to the frame to open and close the aperture defined by the frame.

Advantageously, in use, the pivot shaft may extend between an end surface of the pivoting member and the frame of the closure assembly. Preferably, the pivot shaft is adapted to extend between respective recesses formed within the pivoting member and frame. One or both of the recesses may be defined by a bore directly formed in the pivoting member and frame, or alternatively may be defined by a separate component, such as a bracket or the like, adapted to be secured on or within the member and/or the frame.

Advantageously, two pivot assemblies may be provided. A pivot shaft of one assembly may, in use, extend between one end face of the pivoting member and the frame, and a pivot shaft of the other assembly may, in use, extend between the opposite end face of said member and the frame.

Preferably, the pivot shaft is adapted to be retracted into at least one of the pivoting member and frame. Accordingly, this arrangement permits the pivot shaft to be retracted to disengage the pivot connection between the pivoting member and frame, thus permitting the closure device of the closure assembly to be removed from the frame. In a preferred embodiment, the pivot shaft is adapted to be retracted into the pivoting member. Beneficially, the pivot assembly may further comprise a casing for receiving the pivot shaft.

Advantageously, the pivot shaft may be adapted to be retracted, and extended, by a key formed to engage a portion of the pivot shaft and to effect translation thereof. For example, a portion of the pivot shaft may define a toothed portion, which may be in the form of a rack, and the key may define a complementary toothed portion, which may be in the form of splines to function as a pinion adapted to engage the toothed portion of the pivot shaft, such that rotational movement of the key when engaged with the pivot shaft will result in translation of said shaft. Preferably, one of the frame and pivoting member defines an access bore adapted to receive the toothed portion of the key to permit engagement of the key with the pivot shaft. Advantageously, the access bore may be aligned substantially perpendicular to a central axis of the pivot shaft.

Preferably, the pivot assembly is adapted to be mounted with the pivoting member. More preferably, the pivot assembly is adapted to be mounted with the second member. Advantageously, in this arrangement the access bore may be located in the profiled portion of the second member. Preferably, the access bore is located in the profiled portion of the second member such that access to said bore is permitted when a predetermined relative rotational orientation of the first and second members is achieved. Accordingly, the closure device of the closure assembly with which the safety apparatus is associated, when in use, may only be removed from its frame when said first and second members are positioned in the predetermined relative orientation. Preferably, the access bore formed in the profiled portion of the second member is concealed within the channel of the first member when the closure device is in a closed position relative to the frame. Preferably also, the access bore is revealed when the closure device is in an open position relative to the frame. Accordingly, the closure device may only be removed from its frame when in an open position. This arrangement increases the security of the closure assembly as no access to remove the closure device of the closure assembly will be permitted when in a closed, and possibly locked, position.

Preferably, the pivot assembly further comprises a locking device. Advantageously, the locking device may be adapted to lock the pivot shaft in either an extended or retracted position. Preferably, in use, the locking device is deactivated to unlock the pivot shaft when the key is engaged with the pivot shaft, and the locking device is activated to lock the pivot shaft when the key is disengaged from the pivot shaft. In a preferred embodiment, the locking device comprises a latching mechanism. Advantageously, the latching mechanism may comprise a pawl adapted to engage a ratchet portion associated with the pivot shaft. Conveniently, the ratchet portion may be provided by a toothed portion on the pivot shaft for engaging with the key. Preferably, the locking device comprises biasing means for biasing the latching mechanism towards a locking position. Advantageously, the biasing means may comprise spring biasing means such as a compression spring or the like.

The channel and profiled portion of the first and second members may respectively define complementary cross-sectional profiles. In one embodiment, the channel and profiled portion may be defined by respective arcuate surfaces. The channel may be substantially C-shaped in cross-section, in one embodiment semi-circular in cross-section, and the profiled portion may be generally circular, or at least part circular in cross section. Beneficially, the maximum width of the channel of the first member may be substantially equal to the maximum width of the profiled portion of the second member, such that the channel and profiled portion may be closely fitted together, thus substantially eliminating any gap which may be created therebetween. In one embodiment, a clearance gap may be defined between the respective surfaces of the channel and profiled portion. This arrangement may therefore eliminate or substantially minimise friction between the first and second members when the closure device is pivoted relative to the frame. Alternatively, interference may be established between the respective surfaces of the channel and profiled portion, thus completely eliminating any gap therebetween, preventing any pinch point from being established.

Preferably, the first and second members are adapted to permit the closure device to be pivoted relative to the frame. Advantageously, the first and second members are adapted to permit the closure device to be pivoted relative to the frame by a sufficient degree to permit adequate opening of the aperture defined by the frame. Preferably, the first and second members are adapted to permit the closure device to be pivoted from a closed position relative to the frame by between 45 and 180 degrees, more preferably between 80 and 120 degrees, and most preferably around 90 degrees. In one embodiment of the present invention, the first and second members are adapted to permit the closure device to be pivoted in opposing rotational directions from a closed position relative to the frame.

Advantageously, the first and second members may define limiting means adapted to limit the degree of pivot of the closure device relative to the frame. Preferably, the limiting means comprises a projecting member provided on one of the first and second members, and an abutment member provided on the other of the first and second members, wherein, in use, the projecting and abutment members are adapted to engage to limit the degree of pivot of the closure device relative to the frame. In a preferred embodiment, the projecting member is provided on the profiled portion of the second member, and the abutment member is provided within the profiled channel of the first member. Advantageously, the limiting means may be arranged to prevent pivoting of the closure device relative to the frame beyond a predetermined extent such that substantially all pinch points are eliminated.

Advantageously, one or both of the first and second members may be elongate. Preferably, both the first and second members are elongate and the respective channel and profiled portion extend longitudinally relative to the first and second members.

Preferably, one of the first and second members is adapted to extend along an edge portion of the closure device. More preferably, one of the first and second members is adapted to extend along the entire edge portion of a closure device. Preferably, the first and second members are substantially of the same length.

Advantageously, the first and second members may be adapted to be positioned on a hinge side of the closure assembly. The hinge side of the closure assembly is preferably that side where the closure device is pivotally mounted on the frame.

Preferably, the second member is adapted to be rotated relative to the first member about a first rotational axis, and the closure device is adapted to be pivoted relative to the frame about a first pivot axis. Advantageously, the first rotational axis may be aligned parallel with the first pivot axis of the closure device when the safety apparatus is in use. Preferably, in use, the first rotational axis is coaxial with the first pivot axis of the closure device.

Advantageously, the pivot shaft is axially aligned with the first pivot axis of the closure device.

Advantageously, one of the first and second members may be adapted to be secured to the frame of the closure assembly by, for example, screws, a bolting arrangement, riveting, adhesive bonding, a snap-fit arrangement, interference engagement or the like, or any suitable combination of securing means. In one embodiment, one of the first and second members may comprise at least one longitudinally extending projection adapted to be received within a respective at least one complementary slot or channel formed in the frame portion of the closure assembly. In this arrangement, the member may additionally be secured to the frame portion by adhesive bonding or the like. Alternatively, one of the first and second members may be integrally formed with the frame of the closure assembly.

Beneficially, one of the first and second members may be adapted to be secured to the closure device of a closure assembly by, for example, screws, a bolting arrangement, riveting, adhesive bonding, a snap-fit arrangement, interference engagement or the like, or any suitable combination of securing means. In embodiments of the present invention, one of the first and second members may be integrally formed with the closure device of the closure assembly.

Preferably, the safety apparatus further comprises an intumescent material adapted to be expanded when exposed to elevated temperatures. Advantageously, the intumescent material may be located between the first and second members. For example, the channel of the first member may accommodate the intumescent material such that upon expansion of the material, any gap between the channel of the first member and profiled portion of the second member will be filled, thus establishing a seal, for example in the event of a fire. Alternatively, or additionally, the intumescent material may be located between the first and second members and respective closure device and frame of the closure assembly.

Preferably, the first member is adapted to be coupled to the frame of the closure assembly, and the second member is adapted to be coupled to the closure device of the closure assembly.

Advantageously, one or both of the first and second members may be formed by extrusion, moulding, machining, folding, forming, casting or the like, or any other suitable forming process or combination of forming processes. In embodiments of the invention, one or both of the first and second members may be formed of a metal or metal alloy material, such as steel, aluminium alloy or the like. Alternatively, one or both of the first and second members may be formed of a polymeric material, composite material, wood or the like.

Beneficially, the safety apparatus may optionally comprise a deformable member adapted to be secured to one of the closure device and frame of the closure assembly. More preferably, the deformable member is adapted to be secured to the frame. Advantageously, the deformable member may be secured to the frame at a location opposite the location of the first and second members.

In a preferred embodiment, the deformable member is adapted to be secured to the frame and to be engaged by the closure device when said closure device is pivoted relative to the frame to move towards a closed position.

Preferably, the deformable member comprises a profiled surface adapted to receive a profiled surface of the closure assembly when said closure assembly is moved to a closed position relative to the frame. The deformable member may define a square edged profiled surface adapted to receive a corresponding square edge of the closure device. Alternatively, the deformable member may define a curved profiled surface, more preferably a concaved profiled surface, adapted to receive a rounded profiled edge of the closure device.

Preferably, the deformable member is resilient and preferably elastically deformable. Accordingly, when a body part is located between the closure device and the deformable member when said closure device is moved towards a closed position, the deformable member may advantageously be deformed to accommodate the body part and absorb the force exerted on the body part by the closure member, and subsequently return to its original non-deformed state when the body part is removed. Advantageously, the deformable member may comprise an elastomeric material, such as silicone, rubber or neoprene or the like. Beneficially, the deformable member may define an internal cavity, such that said cavity permits the member to temporarily collapse when a body part is trapped between the deformable member and closure device.

Preferably, the safety apparatus further comprises an intumescent material located adjacent the deformable member, wherein said intumescent material is adapted to expand upon exposure to elevated temperatures. Advantageously, the intumescent material may be located between the deformable member and the frame of the closure assembly, such that upon expansion of the material, any gap between the deformable member and frame will be filled, thus establishing a seal, for example in the event of a fire. Preferably, the intumescent seal is adapted to expand into a cavity defined by the deformable member. Accordingly, expansion of the intumescent material may cause the deformable member to become at least partially expanded, and increase the stiffness thereof, to assist to provide a sufficient seal between the deformable member and a closure device in the event of a fire. In a preferred embodiment, the intumescent material is located adjacent an outer surface of the deformable member and the deformable member comprises a frangible wall portion adapted to be broken upon expansion of the intumescent material, to permit said material to expand internally of the deformable member.

Advantageously, the deformable member may be adapted to be secured to one of the frame and closure member of the closure assembly by, for example, screws, a bolting arrangement, riveting, adhesive bonding, a snap-fit arrangement, interference engagement or the like, or any suitable combination of securing means. In one embodiment, the deformable member may comprise at least one longitudinally extending projection adapted to be received within a respective at least one complementary slot or channel formed in the frame portion of the closure assembly. In this arrangement, the member may additionally be secured to the frame portion by adhesive bonding or the like. Alternatively, the deformable member may be integrally formed with the frame or closure device of the closure assembly.

Preferably, the deformable member comprises a fire resistant material adapted to prevent or at least minimise collapse and/or destruction of the deformable member in the event of a fire, which may compromise any seal formed between the deformable member and closure device. The deformable member may be coated with the fire resistant material. Alternatively, or additionally, the fire resistant material may be enveloped within the deformable member. Preferably, the fire resistant material comprises a sheet material interposed between layers of material forming the deformable member. The sheet material may be integrally moulded with the deformable member. Preferably, the sheet material forms a layer of the deformable member. Advantageously, the deformable member may be formed by a pultrusion process, wherein the sheet material is interleaved between two layers of the deformable member during said pultrusion process. The sheet material may comprise a ceramic paper such as Nextel™ Flame Stopping Dot Paper, for example.

Advantageously, the safety apparatus may comprise a stop member adapted to be secured to a portion of a frame of a closure assembly. Preferably, the stop member is substantially rigid, and in use is adapted to provide a stop against which the closure device of the closure assembly may abut, preventing the closure device from being pivoted relative to a frame beyond a predetermined extent.

In embodiments of the present invention, the safety apparatus may comprise a first support member upon which one of the first and second members are adapted to be mounted. The safety apparatus may comprise a second support member, upon which at least one of the deformable and stop members is adapted to be mounted. Advantageously, the safety apparatus may comprise a third support member upon which the stop member is adapted to be mounted.

Preferably, the support members may define at least a portion of a frame of a closure assembly. For example, the first and second support members may define opposing jamb portions of a door or window frame, and the third support member may define a transom portion of a door or window frame.

Advantageously, the first member may be adapted to be coupled to one of a door and door frame, and the second member may be adapted to be coupled to the other of the door and door frame. In this case, the closure assembly comprises a door.

Alternatively, the first member may be adapted to be coupled to one of a window and window frame, and the second member may be adapted to be coupled to the other of the window and window frame. In this case, the closure assembly comprises a window.

According to a second aspect of the present invention, there is provided a safety system comprising:

a closure device adapted to be pivotally mounted on a frame defining an aperture;

a first member adapted to be coupled to one of the closure device and frame, said first member defining a profiled channel; and

a second member adapted to be coupled to the other of the closure device and frame and defining a profiled portion, wherein said profiled portion is adapted to be received within the profiled channel and to rotate therein when the closure device is pivoted relative to the frame to open and close the aperture,

wherein one of the first and second members is a pivoting member adapted to be pivotally mounted on the frame of the closure assembly via a pivot assembly, wherein said pivoting member is coupled to the closure device, such that said closure device is pivotally mounted on the frame via said pivoting member, said pivoting assembly comprising a pivot shaft adapted to extend between the pivoting member to and frame and adapted to be retracted into at least one of the pivoting member and frame.

Advantageously, one or both of the first and second members may be integrally formed with the respective closure device and frame. Alternatively, one or both of the first and second members may be separately formed and subsequently secured to the respective closure device and frame.

Preferably, the closure device comprises a door. Alternatively, the closure device may comprise a window.

In a preferred embodiment of the present invention, the first member is adapted to be coupled to the frame, and the second member is adapted to be coupled to the closure device.

According to a third aspect of the present invention, there is provided a closure assembly comprising:

a frame defining an aperture;

a closure device adapted to be pivotally mounted on the frame;

a first member adapted to be coupled to one of the closure device and frame, said first member defining a profiled channel; and

a second member adapted to be coupled to the other of the closure device and frame and defining a profiled portion, wherein said profiled portion is adapted to be received within the profiled channel and to rotate therein when the closure device is pivoted relative to the frame to open and close the aperture, wherein one of the first and second members is a pivoting member adapted to be pivotally mounted on the frame via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

According to a fourth aspect of the present invention, there is provided a safety system for a door pivotally mounted on a frame, said safety system comprising;

a first member adapted to be coupled to one of a door and a door frame, said first member defining a profiled channel; and

a second member adapted to be coupled to the other of the door and door frame and defining a profiled portion, wherein said profiled portion is adapted to be received within the profiled channel and to rotate therein when the door is pivoted relative to the door frame to open and close an aperture at least partially defined by the door frame,

wherein one of the first and second members is a pivoting member adapted to be pivotally mounted on the frame of the closure assembly via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

According to a fifth aspect of the present invention, there is provided a safety apparatus comprising:

a first member adapted to be coupled to one of a closure device and frame of a closure assembly, said first member defining a profiled channel;

a second member adapted to be coupled to the other of the closure device and frame and defining a profiled portion, wherein said profiled portion is adapted to be received within the profiled channel and to rotate therein when the closure device is pivoted relative to the frame to open and close an aperture at least partially defined by said frame; and

limiting means adapted to limit the degree of pivot of the closure device relative to the frame.

Preferably, the limiting means comprises a projecting member provided on one of the first and second members, and an abutment member provided on the other of the first and second members, wherein, in use, the projecting and abutment members are adapted to engage to limit the degree of pivot of the closure device relative to the frame. In a preferred embodiment, the projecting member is provided on the profiled portion of the second member, and the abutment member is provided within the profiled channel of the first member. Advantageously, the limiting means may be arranged to prevent pivoting of the closure device relative to the frame beyond a predetermined extent such that substantially all pinch points are eliminated.

### BRIEF DESCRIPTION OF THE DRAWINGS

These and other aspects of the present invention will now be described, by way of example only, with reference to the accompanying drawings, in which:

FIG. 1 is a front view of a door frame according to an aspect of the present invention;

FIG. 2 is a front view of a door for location within the door frame of FIG. 1;

FIG. 3 is a perspective view of a portion of the door of FIG. 2 and frame of FIG. 1, shown engaged together;

FIGS. 4 and 5 are elevational views of a portion of the door and frame with the door shown in closed and open positions respectively;

FIG. 6 is a cross-sectional view of a door jamb portion taken along line 6-6 of FIG. 1;

FIG. 7 is a cross-sectional view of a further door jamb portion taken along line 7-7 of FIG. 1;

FIG. 8 is a further cross-sectional view of the door jamb portion of FIG. 7, shown in a deformed state;

FIG. 9 is a partial sectional view of a portion of the wall of the door jamb portion of FIG. 7;

FIG. 10 is a cross-sectional view of a door transom portion taken along line 10-10 of FIG. 1;

FIG. 11 is a perspective view of a pivot assembly for securing the door of FIG. 2 to the frame of FIG. 1;

FIG. 12 is a perspective view of the door of FIG. 2 shown engaged with a portion of the frame of FIG. 1, wherein the door is shown in an open position.

FIG. 13 is a perspective view of a safety system for a door in accordance with an alternative embodiment of the present invention; and

FIGS. 14 and 15 are elevational views of the door shown in FIG. 13 in closed and opened positions, respectively.

### DETAILED DESCRIPTION OF THE DRAWINGS

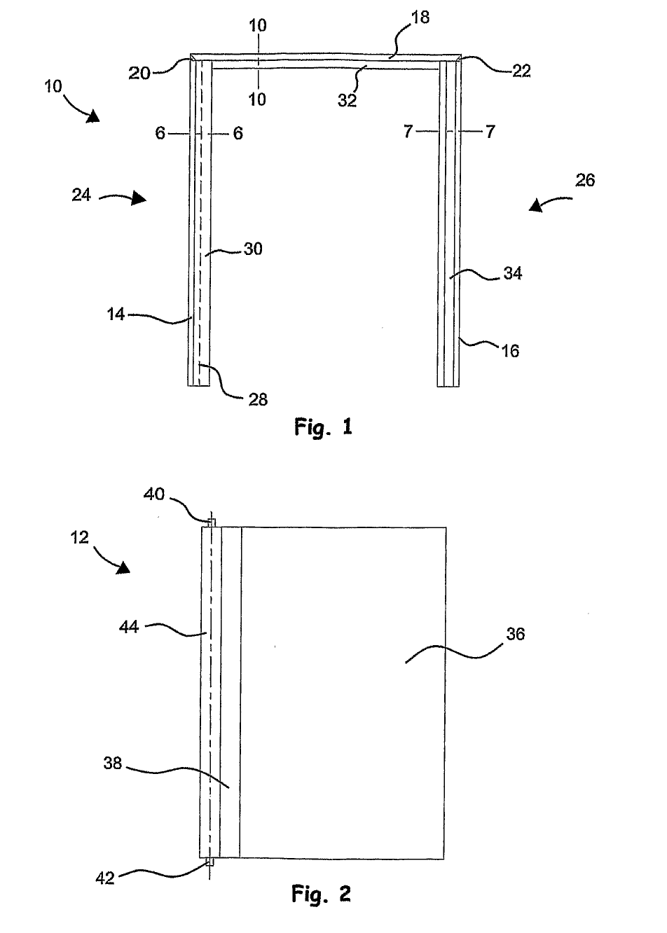

Reference is first made to FIGS. 1 and 2 in which there is shown respectively a front view of a door frame, generally identified by reference numeral 10, and a front view of a door, generally identified by reference numeral 12, wherein said door 12 is adapted to be fitted within said frame 10, as will be discussed in further detail below.

The door frame 10 comprises a first door jamb portion 14, a second door jamb portion 16, and a door transom portion 18. The upper ends of the door jamb portions 14, 16 and the ends of the transom portion 18 are mitred and joined at corners 20, 22 of the frame 10. In the embodiment shown, the door jamb portions 14, 16 are secured to the transom portion 18 by laser welding. The first door jamb 14 is located at a hinge side 24 or the frame 10, and the second portion is located at the opposing, lock side 26 of the frame 10.

Mounted on door jamb 14 is a first elongate member 28 which defines a longitudinal channel 30, shown in broken outline. An elongate stop member 32 is mounted on the transom portion 18, and an elongate deformable member 34 is mounted on door jamb 16. The form and function of the first member 28, stop member 32 and deformable member 34 will be described in detail hereinafter.

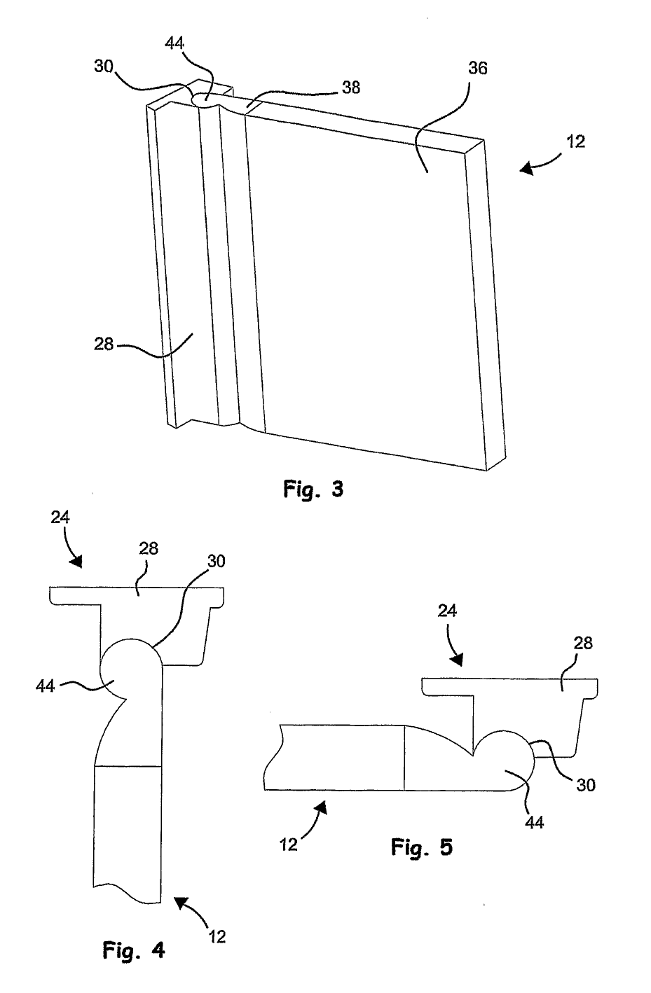

Referring to FIG. 2, the door 12 comprises a substantially planar member 36, one edge of which member 36 is secured to a second elongate member 38, wherein said second elongate member 38 is adapted to be pivotally mounted within the frame 10 of FIG. 1 via upper and lower vertically aligned pivot shafts 40, 42. Thus, the door 12 may be pivoted within the frame 10 to move the door 12 between closed and open positions. The second elongate member 38 incorporates a longitudinal profiled portion 44, wherein said profiled portion 44 is adapted to be received within channel 30 of the first elongate member 28 and rotated therein when the door 12 is pivoted within the frame 10. A perspective view of a portion of the door 12 shown with the profiled portion 44 of elongate member 38 engaged within the channel 30 of elongate member 28 is shown in FIG. 3. As shown, channel 30 is semi-circular in cross-section, and the profiled portion 44 is substantially completely circular in cross-section, thus permitting the profiled portion 44 to be freely rotated within the channel 30, without creation of any significant gaps between the surfaces of the channel 30 and profiled portion 44.

An elevational view of the portion of door 12 and member 28 of FIG. 3 is shown in FIG. 4 with the door 12 shown in a closed position, and in FIG. 5 with the door 12 shown in the open position, wherein the door 12 is rotated relative to the elongate member 28 by around 90 degrees. As shown, the complementary and inter-engaging channel 30 and profiled portion 44 eliminate any pinch points at the hinge side 24, preventing a body part, such as a finger, for example, from becoming trapped and crushed between the door 12 and frame 10.

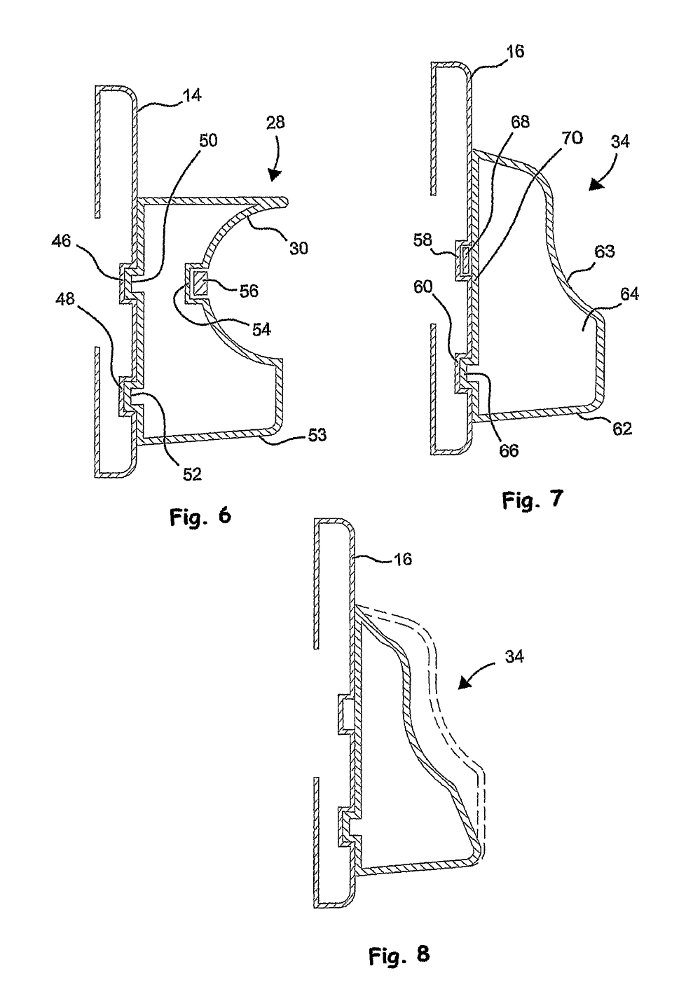

Reference is now made to FIG. 6 in which there is shown a cross-sectional view of door jamb 14 and elongate member 28 taken along line 6-6 of FIG. 1. The door jamb 14 defines two parallel channels 46, 48 within which are located corresponding parallel projections 50, 52 formed on the elongate member 28. The channels 46, 48 and projections 50, 52, together with an adhesive agent, act to secure the elongate member 28 to the door jamb 14. Elongate member 28 comprises a rigid thin walled structure 53 which is formed in the required shape to define channel 30 incorporating projections 50, 52. Located at the base of semi-circular channel 30 is a further longitudinal channel 54 formed by wall 53. Channel 54 is, in use, adapted to receive a strip of intumescent material 56 adapted to be expanded upon exposure to elevated temperatures. Accordingly, in the event of a fire the intumescent strip 56 will expand, thus establishing a seal between the channel 30 and profiled portion 44 of elongate member 38 (FIG. 2).

A cross-sectional view of door jamb 16 and deformable member 34, taken along line 7-7 of FIG. 1, is shown in FIG. 7. The door jamb 16 is identical to door jamb 16 and accordingly comprises two parallel channels 58, 60. The deformable member 34 is formed by a profiled wall 62 composed of an elastomeric material, such as silicone or neoprene or the like, wherein the wall 62 defines an internal cavity 64. The deformable member 34 incorporates a concave wall portion 63 adapted be engaged by an edge portion of the door 12 (FIG. 2), wherein, in the preferred embodiment, the edge portion of the door is rounded to complement the concave wall portion 63 of the deformable member 34. Wall 62 also defines a longitudinal projection 66 which is received in channel 60 of door jamb 16. The projection 66 and channel 60, together with an adhesive agent, act to secure the elongate member 34 to the door jamb 16. A strip of intumescent material 68 is located within channel 58, wherein strip 68 is adapted to be expanded upon exposure to elevated temperatures. Thus, in the event of a fire the strip 68 will expand to provide a seal between the door jamb 16 and deformable member 34. Additionally, the deformable member 34 incorporates a frangible wall region 70 positioned adjacent the intumescent strip 58, such that expansion of strip 58 will rupture the wall region 70 to permit the intumescent material 58 to expand into cavity 64, thus increasing the stiffness of member 34 permitting a sufficient seal to be achieved between the door (FIG. 2) and the concave wall portion 63 of the deformable member 34.

Advantageously, in use, when a body part is located between the door 12 and deformable member 34 when the door is moved towards a closed position, the deformable member 34 will deform to accommodate the body part and to absorb the force exerted on the body part by the door. A diagrammatic representation of the deformable member 34 in a deformed position is shown in FIG. 8, wherein the non-deformed position of the member 34 is shown in broken outline for comparison.

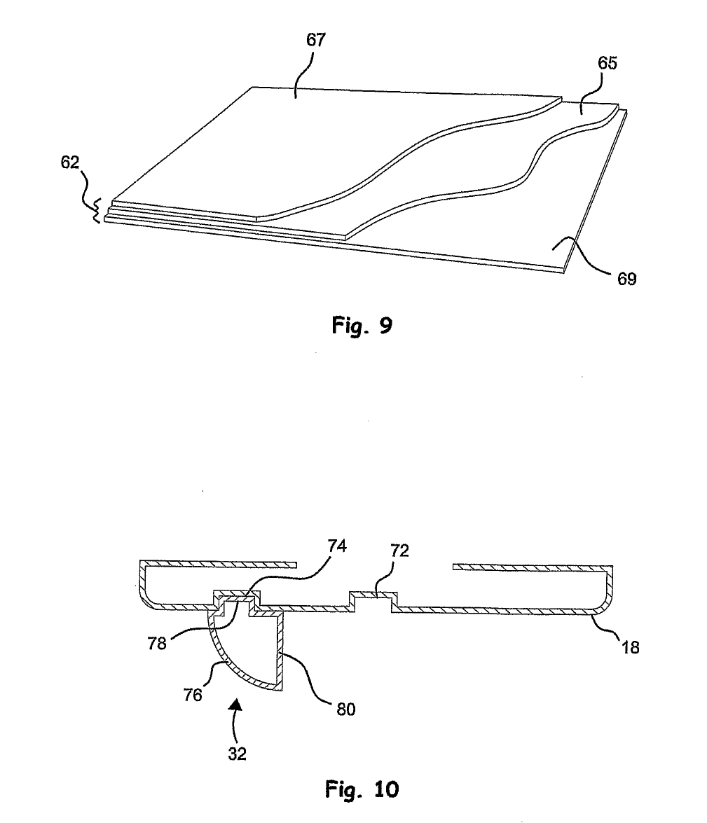

As noted above, the deformable member 34 is composed of an elastomeric material. In a preferred embodiment, the deformable member 34 incorporates a fire or heat resistant material, as shown in FIG. 9, which is a partial sectional view of a portion of the wall 62 of deformable member 34. The wall 62 is preferably formed by a pultrusion process during which a ceramic paper layer 65 is interposed between two layers 67, 69 of elastomeric material. The ceramic paper, in a preferred embodiment, comprises Nextel™ Flame Stopping Dot Paper. Accordingly, when the member 34 is exposed to elevated temperatures, for example in the event of a fire, the outer layer 67 may be destroyed while the ceramic paper layer 65 provides protection to the inner layer 69, thus preventing, or at least minimising collapse and/or destruction of the deformable member 34.

Reference is now made to FIG. 10 in which there is shown a cross-sectional view of the door transom portion 18 and elongate stop member 32, taken along line 9-9 of FIG. 1. The transom portion 18 has a profile identical to door jambs 14, 16 and accordingly defines two parallel channels 72, 74. Thus, the door jambs 14, 16 and transom 18 may be formed from a single profiled channel section, for example a rolled section, cut to the required length. The elongate stop member 32 is formed by a rigid wall structure 76 which incorporates a projection 78 which is received within channel 74, such that the channel 74 and projection, in combination with an adhesive agent, act to secure the stop member 32. The wall 74 of the stop member 32 defines a generally planar abutment portion 80 which extends generally perpendicularly relative to the transom 18. In use, the door 12 (FIG. 2) is adapted to engage the abutment portion 80 of the stop member 76 when the door 12 is in a closed position, wherein the stop member 76 prevents the door being pivoted beyond said closed position.

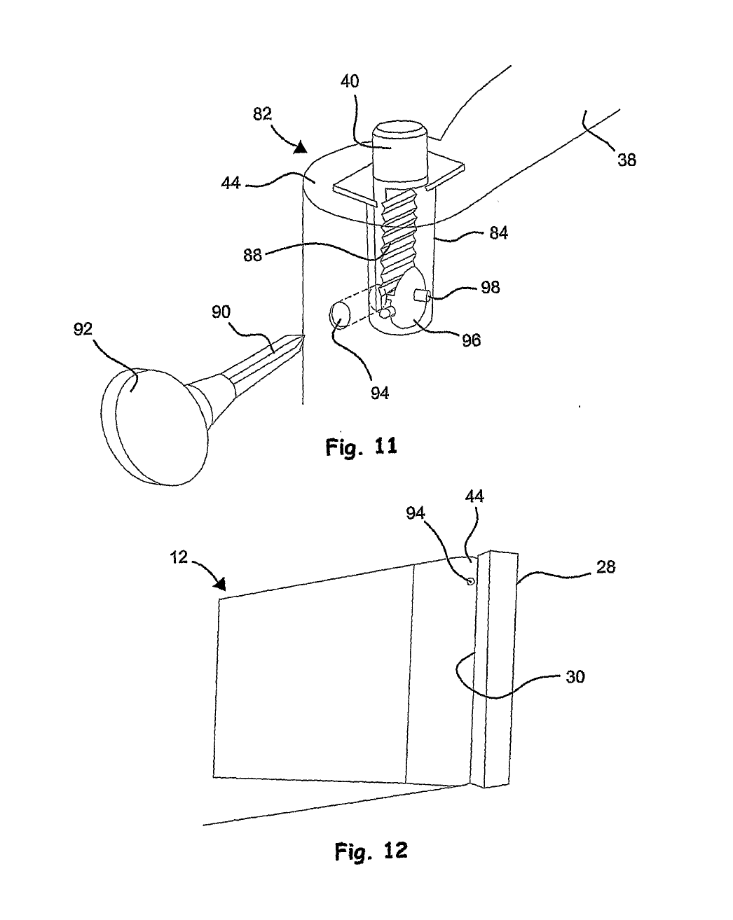

Reference is now made to FIG. 11 of the drawings in which there is shown an enlarged perspective view of a pivot assembly 82, shown inserted into an upper end face of the profiled portion 44 of elongate member 38, wherein said pivot assembly comprises pivot shaft 40 for pivotally mounting the door 12 (FIG. 2) on the frame 10 (FIG. 1). An identical pivot assembly (not shown) is located in the lower end face of the profiled portion 44 and incorporates the lower pivot shaft 42 (FIG. 2). The pivot assembly comprises a casing 84 received within a bore 86 in the profiled portion 44, wherein the casing 84 receives shaft 40 which is adapted to be selectively extended from and retraced into the casing 84, as discussed below.

The shaft 40 defines a toothed portion in to form of a rack 88, wherein the rack 88 is adapted to be engaged by a corresponding toothed portion 90 of a key member 92. In use, the toothed portion 90 of the key 92 is inserted into the profiled portion 44 via a transverse access bore 94 to engage the rack 88, such that rotational movement of the key 92 will cause linear translation of the shaft 40 to cause said shaft 40 to be moved between extended and retracted configurations. In the extended configuration, the shaft 40 is engaged within a recess formed in the transom portion 18 of the frame 10 (FIG. 1), thus permitting the door to be pivotally mounted on the frame, and in the retracted position the shaft is disengaged from said recess in the transom portion thus releasing the door from the frame. This arrangement therefore provides an effective method of pivotally mounting the door, while permitting the door to be simply and quickly removed and remounted, as required.

The pivot assembly 82 further comprises a latch 96 biased by spring 98 against the rack 88 to thus lock said shaft 40 in place. When the key 92 is inserted into bore 94 to engage the rack, engagement of the toothed portion 90 of the key 92 with the latch 96 will act to lift the latch 96 from the rack 88 against the bias of the spring 98, thus unlocking the pivot shaft 40. Once the key 92 is removed from bore 94, the latch 96 will again engage the rack 88 under the bias of spring 98, thus again locking the shaft 40.

It should be noted that the key access bore 94 is positioned on the profiled portion 44 such that access to said bore 94 may only be achieved when the door 12 is in an open position, as shown in FIG. 12. In this arrangement, when the door 12 is in a closed position, access bore 94 will be concealed by the channel 30 of the first elongate member 28, whereas opening the door 12 will result in the access bore 94 being revealed, permitting the key 92 to be inserted. In this way, the door 12 may only be removed from the frame 10 (FIG. 1) when the door is in an open position, thus increasing the security of the door 12.

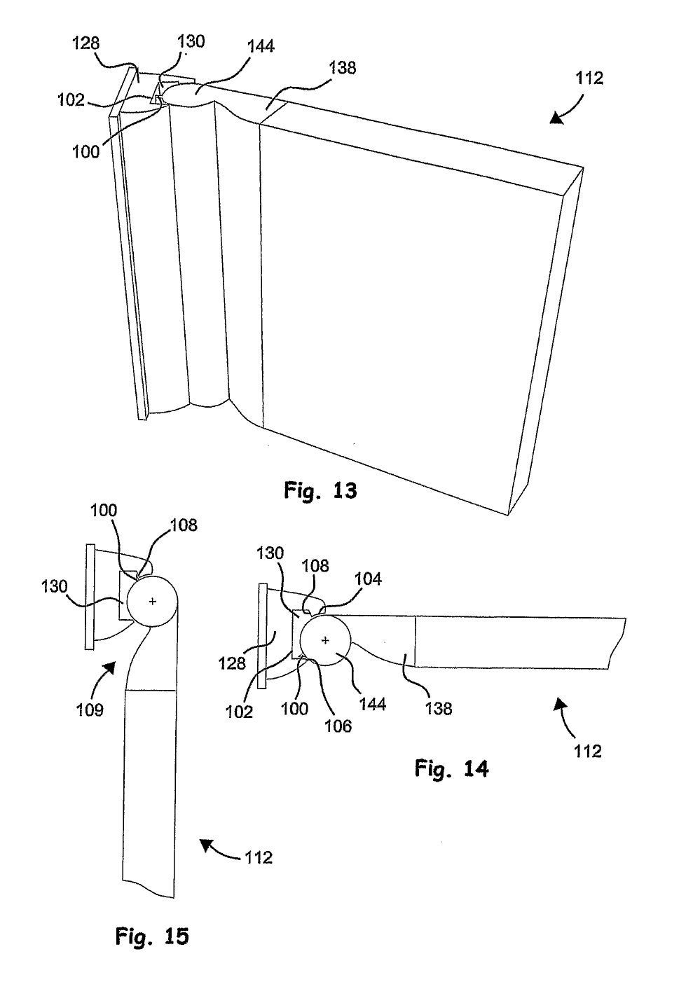

An alternative arrangement to that shown in FIGS. 2 to 5 is shown in FIG. 13, reference to which is now made. The arrangement shown in FIG. 13 is similar to that shown in FIGS. 2 to 5, and as such like components share like reference numerals, incremented by 100. The door 112 also comprises an elongate member 138 defining a profiled portion 144 adapted to be received within channel 130 of elongate member 128. A projecting member 100 extends from the profiled portion 144 of member 138 and into a recessed region 102 of the channel 130. In use, the projecting member 100 limits the degree of pivot of the door 112 relative to its frame (not shown), as discussed in detail below with reference to FIGS. 14 and 15 which are elevational views of the door 112 shown in closed and opened positions respectively.

Referring initially to FIG. 14, the channel 130 defines arcuate surfaces 104, 106 in close relationship with the curved outer surface of the profiled portion 144. Defined between the arcuate surfaces 104, 106 of the channel 130 is the recessed region within which the projecting member 100 is located. When the door 112 is moved towards an open position, as shown in FIG. 15, the projecting member 100 moves to engage an abutment face 108 defined in the channel 130. Engagement of the projecting member 100 with the abutment face 108 thus prevents the door 112 being pivoted further relative to the frame (not shown). This advantageously assists to minimise or eliminate pinch points, especially in region 109. In the embodiment shown in FIGS. 13 to 15, the projecting member 100 and abutment face 108 are arranged to permit the door 112 to be pivoted by approximately 90 degrees relative to the frame (not shown).

The present invention provides an effective and robust component system for protecting fingers and the like from becoming trapped and crushed between doors, windows or the like and their associated frames. Additionally, the system provides protection at those regions where crushing injuries commonly occur in conventional doors and frames, such as the hinge and lock sides.

It should be understood that the embodiments described herein are merely exemplary and that various modifications may be made without departing from the scope of the invention. For example, the system may be used with windows and other closure assemblies and is not limited to doors. Additionally, the system may further include a suitable locking or latching arrangement to maintain the door in a closed position when required. For example, the door may incorporate suitable latching mechanisms, which in some embodiments may be positioned in upper and/or lower surfaces of the door. Furthermore, members 28 and 38 may be divided into a number of separate components and secured to the respective frame and door. Additionally, the deformable member 34 and stop member 32 may be divided into a number of separate components. Additionally, any one of the members 28, 32 and 34 may be integrally formed with the respective frame portions 14, 18 and 16, and member 38 may be integrally formed with the door. Further, the member 28, 32 and 34 may be secured to the frame portions 14, 18 and 16 by any suitable fixing means. Furthermore, the members 28, 32 and 34 may be adapted to be secured to any existing door frame, permitting the system to be readily retrofitted.

1. A safety apparatus comprising:
a first member adapted to be coupled to one of a closure device and frame of a closure assembly, said first member defining a profiled channel; and
a second member adapted to be coupled to the other of the closure device and frame and defining a profiled portion, wherein said profiled portion is adapted to be received within the profiled channel and to rotate therein when the closure device is pivoted relative to the frame to open and close an aperture at least partially defined by said frame,
wherein one of the first and second members is a pivoting member adapted to be pivotally mounted on the frame of the closure assembly via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

2. The safety apparatus of claim 1, wherein, in use, the pivot shaft is adapted to extend between an end surface of the pivoting member and the frame of the closure assembly.

3. The safety apparatus of claim 1, wherein the pivot shaft is adapted to extend between respective recesses formed within the pivoting member and frame.

4. The safety apparatus of claim 1, wherein two pivot assemblies are provided.

5. The safety apparatus of claim 4, wherein a pivot shaft of one assembly, in use, is adapted to extend between one end face of the pivoting member and the frame, and a pivot shaft of the other assembly, in use, is adapted to extend between the opposite end face of said member and the frame.

6. The safety apparatus of claim 1, wherein the pivot shaft is adapted to be retracted into the pivoting member.

7. The safety apparatus of claim 1, wherein the pivot shaft is adapted to be retracted, and extended, by a key formed to engage a portion of the pivot shaft and to effect translation thereof.

8. The safety apparatus of claim 7, wherein a portion of the pivot shaft defines a toothed portion and the key defines a complementary toothed portion adapted to engage the toothed portion of the pivot shaft, such that rotational movement of the key when engaged with the pivot shaft will result in translation of said shaft.

9. The safety apparatus of claim 8, wherein one of the frame and pivoting member defines an access bore adapted to receive the toothed portion of the key to permit engagement of the key with the pivot shaft.

10. The safety apparatus of claim 1, wherein the pivot assembly is adapted to be mounted with the pivoting member.

11. The safety apparatus of claim 1, wherein the pivot assembly is adapted to be mounted with the second member.

12. The safety apparatus of claim 11, wherein an access bore is located in the profiled portion of the second member.

13. The safety apparatus of claim 12, wherein the access bore is located in the profiled portion of the second member such that access to said bore is permitted when a predetermined relative rotational orientation of the first and second members is achieved.

14. The safety apparatus of claim 13, wherein the access bore formed in the profiled portion of the second member is concealed within the channel of the first member when the closure device is in a closed position relative to the frame.

15. The safety apparatus of claim 1, wherein the pivot assembly further comprises a locking device.

16. The safety apparatus of claim 15, wherein the locking device is adapted to lock the pivot shaft in either an extended or retracted position, or any position therebetween.

17. The safety apparatus of claim 16, wherein, in use, the locking device is deactivated to unlock the pivot shaft when a key is engaged with the pivot shaft, and the locking device is activated to lock the pivot shaft when said key is disengaged from the pivot shaft.

18. The safety apparatus of claim 15, wherein the locking device comprises a latching mechanism.

19. The safety apparatus of claim 18, wherein the latching mechanism is biased towards a locking position.

20. The safety apparatus of claim 1, wherein the channel and profiled portion of the first and second members respectively define complementary cross-sectional profiles.

21. The safety apparatus of claim 1, wherein the channel and profiled portion are defined by respective arcuate surfaces.

22. The safety apparatus of claim 1, wherein the channel is semi-circular in cross-section.

23. The safety apparatus of claim 1, wherein the profiled portion is generally circular in cross-section.

24. The safety apparatus of claim 1, wherein the first and second members are adapted to permit the closure device to be pivoted relative to the frame.

25. (canceled)

26. (canceled)

27. The safety apparatus of claim 1, wherein one or both of the first and second members are elongate.

28. The safety apparatus of claim 1, wherein both the first and second members are elongate and the respective channel and profiled portion extend longitudinally relative to the first and second members.

29. The safety apparatus of claim 1, wherein one of the first and second members is adapted to extend along an edge portion of the closure device.

30. (canceled)

31. (canceled)

32. The safety apparatus of claim 1, wherein the first member is adapted to be coupled to the frame of the closure assembly, and the second member is adapted to be coupled to the closure device of the closure assembly.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. The safety apparatus of claim 1, further comprising a stop member adapted to be secured to a portion of a frame of a closure assembly.

46. The safety apparatus of claim 1, further comprising a first support member upon which one of the first and second members are adapted to be mounted.

47. The safety apparatus of claim 46, further comprising a stop member and a second support member, upon which second support member and the at least one of the deformable and stop members is adapted to be mounted.

48. (canceled)

49. The safety apparatus of claim 1, wherein the first member is adapted to be coupled to one of a door and door frame, and the second member is adapted to be coupled to the other of the door and door frame.

50. The safety system of claim 1, wherein the first member is adapted to be coupled to one of a window and window frame, and the second member is adapted to be coupled to the other of the window and window frame.

51. According to a second aspect of the present invention, there is provided a safety system comprising:
a closure device adapted to be pivotally mounted on a frame defining an aperture;
a first member adapted to be coupled to one of the closure device and frame, said first member defining a profiled channel; and
a second member adapted to be coupled to the other of the closure device and frame and defining a profiled portion, wherein said profiled portion is adapted to be received within the profiled channel and to rotate therein when the closure device is pivoted relative to the frame to open and close the aperture,
wherein one of the first and second members is a pivoting member adapted to be pivotally mounted on the frame of the closure assembly via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

52. A closure assembly comprising:
a frame defining an aperture;
a closure device adapted to be pivotally mounted on the frame;
a first member adapted to be coupled to one of the closure device and frame, said first member defining a profiled channel; and
a second member adapted to be coupled to the other of the closure device and frame and defining a profiled portion, wherein said profiled portion is adapted to be received within the profiled channel and to rotate therein when the closure device is pivoted relative to the frame to open and close the aperture,
wherein one of the first and second members is a pivoting member adapted to be pivotally mounted on the frame via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

53. A safety system for a door pivotally mounted on a frame, said safety system comprising;
a first member adapted to be coupled to one of a door and a door frame, said first member defining a profiled channel; and
a second member adapted to be coupled to the other of the door and door frame and defining a profiled portion, wherein said profiled portion is adapted to be received within the profiled channel and to rotate therein when the door is pivoted relative to the door frame to open and close an aperture at least partially defined by the door frame,
wherein one of the first and second members is a pivoting member adapted to be pivotally mounted on the frame of the closure assembly via a pivot assembly, wherein said pivoting member is coupled to the closure device, such that said closure device is pivotally mounted on the frame via said pivoting member, said pivoting assembly comprising a pivot shaft adapted to extend between the pivoting member and frame and adapted to be retracted into at least one of the pivoting member and frame.

54. (canceled)

55. The safety apparatus of claim 1, wherein the pivot shaft is adapted to be retracted from the frame and into the pivoting chamber.
